(19) United States
(12) Patent Application Publication
(10) Pub. No.: US 2004/0112434 A1
(43) Pub. Date: Jun. 17, 2004

(54) Exterior water faucet assembly incorporating locking key and cylinder

(76) Inventor: Daryl Harvey, Detroit, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/279,322

(22) Filed: Dec. 11, 2002

(51) Int. Cl. F16K 35/00

(52) U.S. Cl. 137/383

(57) ABSTRACT

A lockable exterior water faucet assembly including a spigot with a neck portion extending from a fluid supply line and communicating with a second substantially hollowed body portion. An exteriorly threaded and annular extending outlet is located proximate a forward face of the hollowed body portion of the spigot. A cylinder with an extending seal plug is insertably engaging through a rearward face of the hollowed body portion and so that the seal plug engages an interior and fluid communicating location of the spigot outlet in a first closed position. A key engages a key slot defined within an exposed rearwardly directed end of the cylinder. The key is actuated a selected rotational distance to actuate the cylinder and to cause the seal plug to unseat from the spigot outlet in a second opening position.

### BACKGROUND OF THE INVENTION

1. Field of the Invention

The present invention relates generally to faucet locking devices and, more particularly, to a locking key and cylinder arrangement for use with an exteriorly located water faucet assembly

2. Description of the Prior Art

The prior art is well documented with examples of anti-tampering locking devices for use with, among other things, faucet or spigot assemblies. The objective of the relevant art, in each instance, is to prevent the unauthorized use or tampering of the spigot assembly, such as during periods of non-use and further during which the faucet is unattended.

A first example of the prior art is set forth in U.S. Pat. No. 5,607,084, issued to George, and which teaches a locking system for beverage taps, such as in particular for beer kegs, and which incorporates an elongated valve stem which protrudes from a proximal end of a faucet body and is provided with an axial end bore having pin threads therein. A lock subassembly, actuated by a key, attaches to the valve stem by a threaded driver pin, which engages the pin threads. A case cylinder encloses the engagement position and overlaps a portion of the faucet body and such that anti-rotation ears prevent relative rotation and loosening of the engagement except when the key is utilized. When tightened, the lock subassembly forces the valve stem into a closed position, preventing opening of the faucet and dispensing of beverages.

Dixon 5,287,874 teaches an anti-use cap for an exterior water faucet, the cap including an elongated body with screw threads formed on one end. An interior cavity extends axially away from the threads and toward an opposite end, the cavity being defined in part by a generally transverse face disposed radially in from the threads and an elongated smaller closed end bore extended axially from the transverse face. The threads and face are sized to correspond to the threads and transverse face on a packing nut used on an exterior water faucet, and the bore would be sized with sufficient diameter and length to fit with clearance over the faucet stem. The cap further precludes unauthorized use of the faucet by replacing the faucet packing nut with it, when then would overlie the stem and preclude opening or closing actuation of the faucet.

A further class of prior art references teaches the ability to cover the existing spigot outlet with a separate locking device. Examples of such references include Royka, Jr. 5,649,437 which teaches a lockable cover for a threaded nozzle, such as a hose bib and having a passageway, end face and external threaded portion adjacent the end face for locking and sealing the passageway of a spout having an anti-siphon valve in the passageway and further including a portion protruding outward from an end face thereof. Additional examples of similar locking devices are shown in Woolvin 4,516,414, Erickson, 5,176,014, and Munsterer 5,247,816.

A final class of prior art discloses the provision of lockable cages or enclosures for securing to such as an exterior (or interior) application. An example of such a device is set forth in U.S. Pat. No. 5,927,111, issued to Nachbauer and which illustrates first and second pivotally secured housing halves which are secured to a building wall in proximate and enclosing fashion about a conventional faucet.

### SUMMARY OF THE PRESENT INVENTION

The present invention discloses an improved exterior water faucet assembly incorporating a locking key and cylinder arrangement which is distinguishable in particular over the teachings of such as the George and Dixon patent references. In particular, the present invention teaches a simplified and integrated key and cylinder arrangement for quickly and efficiently locking and unlocking the faucet and which improves over Dixon which requires the provision of special manual tool and interlock for threadably tightening or loosening the cap relative to the exterior faucet.

In particular, the lockable exterior water faucet assembly includes a spigot having a neck portion extending from a fluid supply line and communicating with a second substantially hollowed body portion. The hollowed body defines the main body of the spigot and an exteriorly threaded and annular extending outlet is located proximate a forward face of the hollowed body portion of the spigot.

A cylinder with extending seal plug is insertably engaged through a rearward face of the hollowed body portion and so that the seal plug engages an interior and fluid communicating location of the spigot outlet in a first position. A key engages a key slot defined within an exposed end of the cylinder, the key being actuated a selected rotational distance to actuate the cylinder and to cause the seal plug to unseat from the spigot outlet in a second opening position.

In a first preferred variant, interengaging pluralities of annular threads are defined between exterior surface cylinder and the opposing and inwardly directed surfaces of the hollowed body portion. Additional interengaging pluralities may also in this variant be defined between the seal plug and associated annular abutting location of the spigot outlet and which, in combination with the interengaging threads of the cylinder and hollowed body portion, are successively rotated in either opening or closing directions to unseat or reseat the seal plug relative to the spigot outlet.

In a further preferred variant, the interengaging pluralities of threads are substituted by a pair of tabs extending radially from locations of the cylinder and, in the first closed position, seat within corresponding recesses defined in the hollowed body portion. A pair of axially extending and channeled slots are further defined between the cylinder and opposing annular surfaces of the hollowed body portion.

The cylinder is capable of being rearwardly displaced after the cylinder is rotated by the key a selected incremental distance and in order to unseat the tabs from the closed position serating recesses. Successive rearward actuation of the cylinder is accomplished upon aligning the tabs with axially extending and channeled slots defined between the cylinder and the hollowed body, the cylinder engaging a further pair of radially offset seating portions located at the rearward face of the hollowed body portion and which defines the second opened position of the seal plug.

An additional feature of this further variant includes the provision of an “O” ring seal extending in annular fashion and at a specified axial location between the cylinder and the hollowed body portion. The purpose of the “O” ring seal, as such is conventionally known in the art, is to prevent leakage of pressurized water through the rearward face of the body and at the boundary defined between the cylinder and the cylindrical seating configuration of the hollowed body.

Additional features include the seal plug further exhibiting a rubberized and annular sealing member located thereupon as well as an interconnecting stein portion extending between the cylinder and the seal plug. An additional feature of the second preferred variant includes the provision of a coil spring placeable around the stem portion and biasing against an interior end face location of the hollowed body portion in order to bias the seal plug in the first engaging position.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a side cutaway view of the lockable exterior water faucet assembly according to a first preferred variant of the present invention;

FIG. 2 is an end sectional view taken along line 2-2 of FIG. 1 and illustrating the configuration of the key lock relative to the exposed rearward end face of the hollowed body portion;

FIG. 3 is a perspective view, in partial cutaway, and exhibiting an exterior configuration of the lockable water faucet assembly;

FIG. 4 is a sectional view in perspective of the cylinder with stem portion and extending seal plug according to the present invention;

FIG. 5 is an illustration of an insertable key according to the present invention;

FIG. 6 is a side cutaway view similar to that shown in FIG. 1 and exhibiting a lockable water faucet assembly according to a further preferred variant and in which a combination of radially extending tabs, seating recesses and axially extending channeled slots are defined between the cylinder and hollowed body portion in order to rearwardly actuate the cylinder and associated seal plug; and

FIG. 7 is an end view taken along line 7-7 of FIG. 6 and illustrating the arrangement of the tabs, seating recesses and channeled slots also shown in FIG. 6.

### BRIEF DESCRIPTION OF THE DRAWINGS

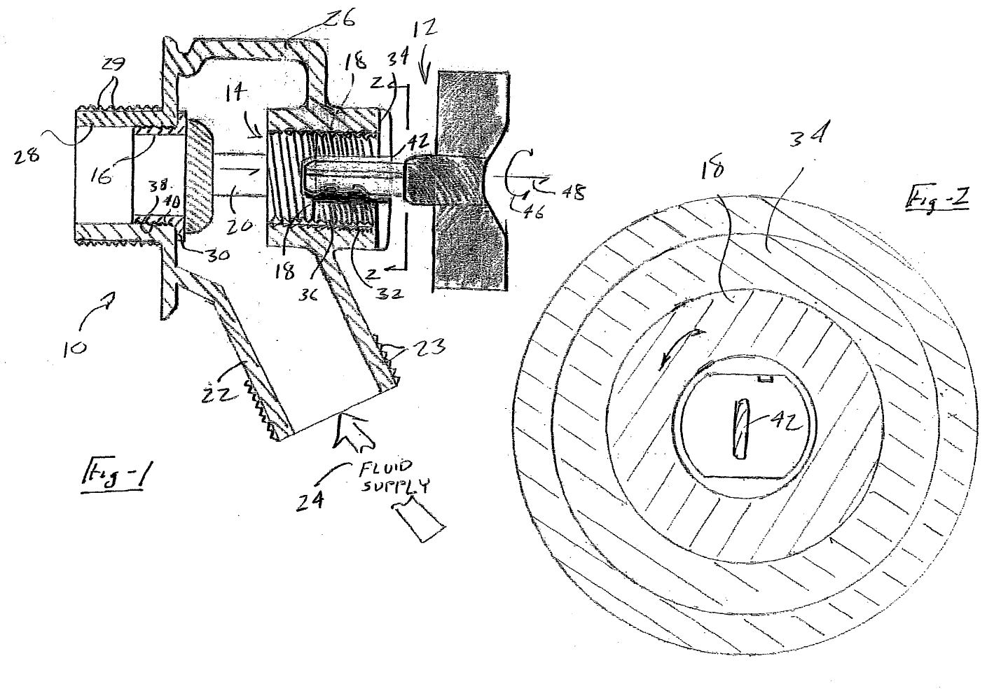

Referring now to FIG. 1, an improved exterior water faucet assembly is illustrated at 10 according to a first preferred embodiment of the present invention. As previously explained, the locking faucet assembly incorporates a locking key 12 and cylinder 14 arrangement which is distinguishable in particular over the teachings of such as the George and Dixon patent references. In particular, the present invention teaches a simplified and integrated key and cylinder arrangement for quickly and efficiently locking and unlocking a seal plug 16 interconnected to a main body 18 of the cylinder by means of a stem portion 20.

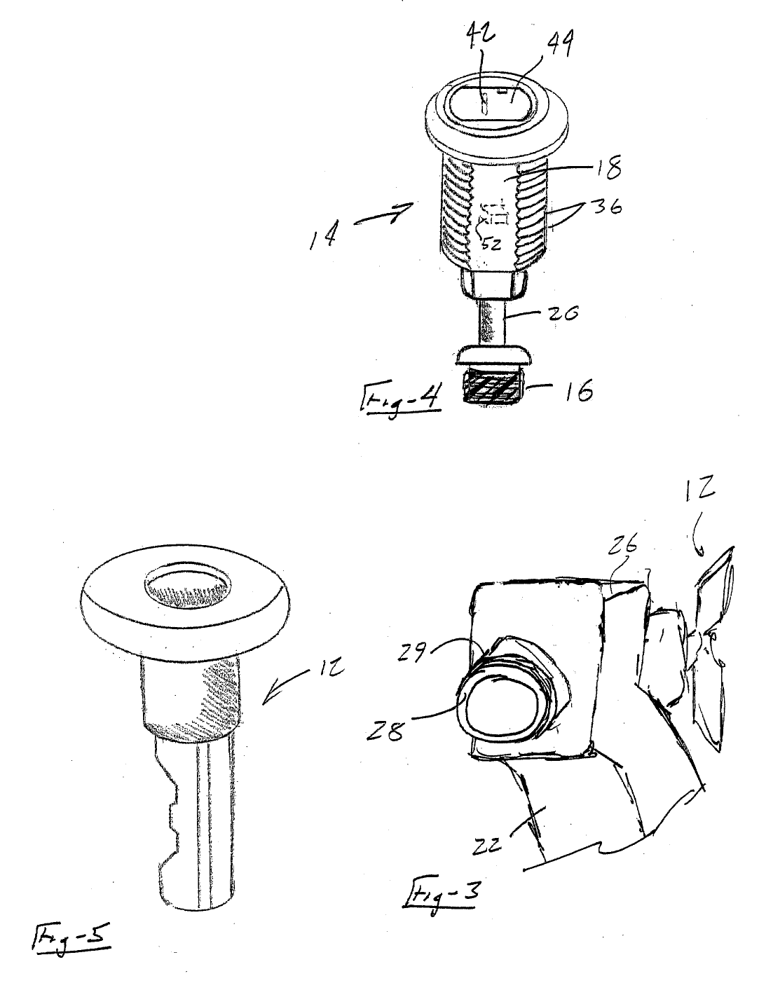

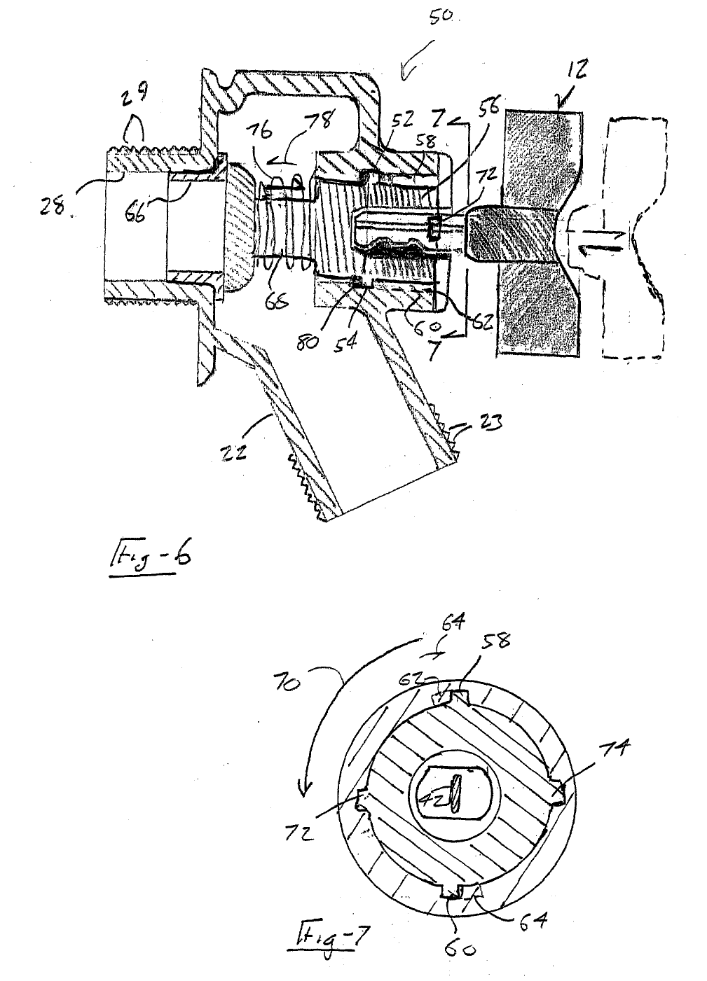

Referring again to FIG. 1, as well as to succeeding FIGS. 2-5, the lockable exterior water faucet assembly includes a spigot having a neck portion 22 extending from a fluid supply line (see as generally referenced at 24 in FIG. 1) and which communicates with a second substantially hollowed body portion 26 which defines a main interior body of the spigot. Threads are also illustrated at 23 extending in annular fashion around the extending neck portion 22 of the spigot and, in a further contemplated variant, the spigot can be portable for attaching to a suitable interiorly threaded coupling.

The interiorly hollowed body further includes an exteriorly threaded and annular extending outlet 28 (and exhibiting exterior threads 29 on an outer annular surface for receiving corresponding interior threads of a suitable hose coupling, not shown). The outlet 28 is located proximate a forward face of the hollowed body portion and is further defined at an interior end by an annular extending end wall 30. A substantially cylindrically shaped channel 32 is defined at a substantially rearward end location of the internally hollowed body and in a substantially axially extended and aligning fashion with the forward outlet 28.

The cylinder, as again generally referenced at 14 with the extending seal plug 16, main body 18 and interconnecting stem 20, is insertably engaged through a rearward face 34 of the hollowed body portion (typically in communicating fashion with the cylindrically shaped and extending channel 32). In this fashion, the extending seal plug 16 engages against the interior and fluid communicating location of the spigot outlet 28, and in particular its annular extending end wall 30 as shown in FIG. 1, in a first engaged position.

As further referenced in the variant of FIG. 1, interengaging pluralities of annular threads are defined between the annular exterior surface of the main body 18 of the cylinder 14, see at 36, and the opposing and inwardly directed surfaces of the extending channel 32. Additional interengaging pluralities may also in this variant be defined between the seal plug 38 and associated annular abutting location 40 of the spigot outlet.

The key 12 engages a key slot 42 defined within the exposed rear end of the cylinder 18. A key locking mechanism, such as is illustrated at 44 in FIG. 4, is provided according to conventional manufacture and so that, upon insertion of the key 12, is capable of being actuated in a selected rotational direction.

In use, and upon inserting the key 12 into the slot 42 and rotating in a selected direction, the cylinder 14 is with extending seal plug 16 is caused to unseat from the spigot outlet 28 and towards a second and rearwardly displaced/opening position. Displacement of the main cylinder body 18 and seal plug 16 is caused by the rotative engagement between the opposing threaded portions (see again at 32, 36 and 38, 40) and, in combination, are successively rotated in either opening or closing directions to unseat or reseat the seal plug 16 relative to the spigot outlet 28 and in particular its annular end walls 30. Reference is further made to rotational directional arrow 46 in FIG. 1 which illustrates the bi-directional rotative aspect of the key 12 and cylinder 14, as well as linear directional arrow 48 which illustrates the rearward actuating direction of the key 12, cylinder 18, interconnecting stein 20, and extending seal plug 1 as previously described.

Although not shown, it is understood that sufficient resistive engagement may exist between the main cylinder body 18 and extending channel 32, as well as between the seal plug 16 and spigot outlet 28, and in order to maintain fluid tight integrity to the system. This may also be accomplished by constructing or coating the interengaging threads 32, 36, 38 and 40 with a suitable impermeable rubberized composition to maintain its fluid tight nature in both opened or closed positions.

Referring now to FIGS. 6 and 7, a further preferred variant is illustrated at 50 of the faucet assembly. In this variant, the interengaging pluralities of threads are substituted by a pair of tabs (see at 52 and 54) extending radially from locations of the main cylinder body, here shown at 56. A selected radially extending tab 52 is also shown in phantom in the illustration of FIG. 4 and is intended to reference the alternate arrangement of FIGS. 6 and 7, again without provision of any threads placed upon the cylinder body and extending seal plug.

A pair of axially extending and channeled slots 58 and 60 are further defined between the main cylinder body 56 and opposing annular surfaces of the hollowed body portion, such as again defined by the rearwardly extending channel, here referenced at 62. The cylinder is capable of being rearwardly displaced upon insertion of the key 12 (such as again into the key slot 42) and first rotating the key 12 a selected incremental distance (see at 64 in the end view of FIG. 7) and in order to unseat the tabs 52 and 54 from associated seating recesses 62 and 64 (again FIG. 7) corresponding to the first closed position.

Upon aligning the tabs 52 and 52 within the rearwardly extending channels 58 and 60, the cylinder, and seal plug 66 interconnected by stem 68, is successively rearwardly actuated until the cylinder is withdrawn a distance from the hollowed body. At that point, the key 12 is rotated, in the instance of FIG. 7 approximately 90 degrees along directional arrow 70, and so that the tabs 52 and 54 engage a further pair of radially offset seating portions, see at 72 and 74 in FIG. 7, located at the rearward face of the hollowed body portion and which defines the second opened position of the seal plug. An additional feature of the second preferred variant includes the provision of a coil spring 76, placeable around the stem portion 68, and biasing against an interior end face location of the hollowed body portion in order to bias the seal plug 66 in a direction towards the first engaging position and as shown by arrow 78.

Yet additional features of this further variant includes the provision of an “O” ring seal 80 extending in annular fashion and at a specified axial location between the cylinder 56 and the channel 62 of the hollowed body portion. The purpose of the “O” ring seal 80, as such is conventionally known in the art, is to prevent leakage of pressurized water through the rearward face of the body and at the boundary defined between the cylinder and the cylindrical seating configuration of the hollowed body. Referring again to FIGS. 4 and 6, the seal plug in either variant (16 or 66) may further exhibit a rubberized and annular sealing material located thereupon to assist in its fluid sealing characteristics.

Having described my invention, additional preferred embodiments will become apparent to those skilled in the art to which it pertains, and without deviating from the scope of the appended claims.

I claim:

1. A lockable exterior water faucet assembly, comprising:
a spigot having a neck portion extending from a fluid supply line and communicating with a second substantially hollowed body portion;
an exteriorly threaded and annular extending outlet being located proximate a forward face of said hollowed body portion of said spigot;
a cylinder with extending seal plug insertably engaging through a rearward face of said hollowed body portion and so that said seal plug engages an interior and fluid communicating location of said spigot outlet in a first position; and
a key engaging a key slot defined within an exposed end of said cylinder, said key being actuated a selected rotational distance to actuate said cylinder and to cause said seal plug to unseat from said spigot outlet in a second position.

2. The lockable water faucet assembly as described in claim 1, further comprising interengaging pluralities of annular threads defined between said cylinder and said hollowed body portion.

3. The lockable water faucet assembly as described in claim 2, further comprising:
a pair of tabs extending radially from said cylinder and seating within corresponding recesses defined in said hollowed body portion; and
a pair of axially extending and channeled slots defined between said cylinder and opposing annular surfaces of said hollowed body portion, said cylinder being rearwardly displaced after actuating said selected rotational distance, said cylinder engaging a further pair of radially offset seating portions located at said rearward face of said hollowed body portion.

4 The lockable water faucet assembly as described in claim 3, further comprising an “O” ring seal extending in annular fashion and at a specified axial location between said cylinder and said hollowed body portion.

5. The lockable water faucet assembly as described in claim 1, said seal plug further comprising a rubberized and annular sealing member located thereupon.

6. The lockable water faucet assembly as described in claim 3, further comprising an interconnecting stem portion between said cylinder and said seal plug.

7. The lockable water faucet assembly as described in claim 6, further comprising a coil spring placeable around said stein portion, said spring biasing against an interior location of said hollowed body portion and biasing said seal plug in said first engaging position.

8. A lockable exterior water faucet assembly, comprising:
a spigot having a neck portion extending from a fluid supply line and communicating with a second substantially hollowed body portion;
an exteriorly threaded and annular extending outlet being located proximate a forward face of said hollowed body portion of said spigot;
a cylinder with extending seal plug insertably engaging through a rearward face of said hollowed body portion and so that said seal plug engages an interior and fluid communicating location of said spigot outlet in a first closed position, interengaging pluralities of annular threads being defined between said cylinder and said hollowed body portion; and
a key engaging a key slot defined within an exposed end of said cylinder, said key being actuated in a selected rotational direction to rotate and successively unseat said cylinder in a rearward direction from said hollowed body portion, thereby causing said seal plug to unseat from said spigot outlet in a second open position.

9. A lockable exterior water faucet assembly, comprising:
a spigot having a neck portion extending from a fluid supply line and communicating with a second substantially hollowed body portion;
an exteriorly threaded and annular extending outlet being located proximate a forward face of said hollowed body portion of said spigot;
a cylinder with extending seal plug insertably engaging through a rearward face of said hollowed body portion and so that said seal plug engages an interior and fluid communicating location of said spigot outlet in a first closed position, a pair of tabs extending radially from said cylinder and seating within corresponding recesses defined in said hollowed body portion;
a pair of axially extending and channeled slots defined between said cylinder and opposing annular surfaces of said hollowed body portion; and
a key engaging a key slot defined within an exposed end of said cylinder, said key being actuated in a selected rotation direction so that said extending tabs align with said channeled slots to allow said cylinder to be rearwardly displaced and said seal plug to unseat from said spigot outlet, said tabs engaging a further pair of radially offset seating portions located at said rearward face of said hollowed body portion to position said seal plug in a second open position.
